(19) United States
(12) Patent Application Publication
(10) Pub. No.: US 2026/0216582 A1
(43) Pub. Date: Jul. 30, 2026

(54) AN ACTIVITY TRACKING APPARATUS AND SYSTEM

(71) Applicant: ATTA Technologies Limited, Kowloon, Hong Kong (CN)

(72) Inventors: Nicholas Ronald Youde Chao, Kowloon, Hong Kong (CN); Thomas Hon Cheung Jor, Kowloon, Hong Kong (CN); Tsz Kit Gabriel Pang, Kowloon, Hong Kong (CN)

(21) Appl. No.: 19/147,097

(22) PCT Filed: Jan. 31, 2023
(86) PCT No.: PCT/CN2023/073993

§ 371 Date: Jul. 10, 2025

(51) Int. Cl. A63B 71/06; G06T 7/246; G06V 40/20

(52) U.S. Cl. CPC A63B 71/0622; G06T 7/251; G06V 40/23

(57) ABSTRACT

A system for an activity tracking apparatus for tracking performance of one or more activities by a user includes: a body, a camera configured to capture one or more images of a user performing a physical activity, wherein the activity tracking apparatus is configured to: capture, by the camera, one or more images of a user performing a physical activity with an equipment, process the one or more captures images and determine movement of the user, process the one or more captured images and determine movement of the equipment, identify a physical activity being performed by a user based on the movement of the user and the movement of the equipment.

### TECHNICAL FIELD

The present invention relates to an activity tracking apparatus and activity tracking system, for tracking performance of one or more activities and/or training users in one or more physical activities.

### BACKGROUND

Sports and exercises are an important part of Physical Education and ongoing development for adults and children. Many participants often require coaching or instruction in sports or exercise or other physical activities. Coaching and instruction can be important in sports as it allows participants to progress and improve their skill. Similarly in exercise instruction and coaching, there is a need to improve the quality and safety of the exercise. Additionally, it is quite important to track progress within a sport or within an exercise.

Some of the common issues participants face are difficulties in accessing systematic training programs for sport or exercise. There are several general training programs but sport specific or activity specific programs are difficult to access. Several of the sport or activity specific programs are often too expensive for most people to access. In person instruction is not easily accessible due to a shortage of professional expertise to provide guidance. Additionally in person instruction (i.e., coaching) for a sport or exercise can be very expensive and often unaffordable for most people.

Data tracking is a challenge for users. Although there are data recording devices often there is a lack of detailed quantifiable data for performance tracking. Additionally, it can be challenging to track progress of a user performing an exercise or playing a sport. Tracking progress may be done by manual note taking or other apps that allow some tracking. Tracking progress requires a user to input data regarding the physical activity. However, it is difficult to track progress and measure quality of the physical activity.

### SUMMARY OF THE INVENTION

The present invention relates to an activity tracking apparatus and system for training users in one or more physical activities and/or tracking performance of the one or more activities. The physical activities may be any physical activity performed by a person i.e., a user of the apparatus or system. Preferably the physical activities are sports or exercises. The apparatus and system are configured to train a user to perform an exercise or play a sport. The apparatus and system are further configured to track performance of a sport or an exercise by a user. A user may be a subject that uses the activity tracking apparatus or activity tracking system.

Several sports are performed with equipment i.e., various types of equipment. Some examples are balls, bats etc. Many exercises are also performed with equipment such as for example kettlebells, clubbells, barbells, skipping ropes etc. Equipment as used herein means an object that is used by the user to perform a specific type of sport or exercise (i.e., a specific type of physical activity). Many sports and exercises are defined by the way a user interacts with the equipment and by the movement of the equipment.

The activity tracking apparatus is configured to capture images of a user performing an activity, process the images and determine the type of activity being performed by the user based on identifying movement of the equipment in the image and/or the movement of the user. The activity tracking apparatus may be configured to track specific performance metrics associated with an activity. The activity tracking system comprises the activity tracking apparatus and an analytics platform. The analytics platform may be a computing system e.g., a server. The activity tracking apparatus is configured to record data regarding an activity being performed by the user and transmit this data to the analytics platform. The analytics platform is configured to present data regarding an activity to the user. The analytics platform may be configured to perform process the data (e.g., perform diagnostics or other analytics) and present one or more performance metrics to a user.

In accordance with a first aspect of the present invention, there is provided an activity tracking apparatus for tracking performance of one or more activities by a user, the apparatus comprising:
a body,
a camera configured to capture one or more images of a user performing a physical activity,
wherein the activity tracking apparatus is configured to:
capture, by the camera, one or more images of a user performing a physical activity with an equipment,
process the one or more captured images and determine movement of the user,
process the one or more captured images and determine movement of the equipment,
identify a physical activity being performed by a user based on the movement of the user and the movement of the equipment.

In an embodiment of the first aspect, the camera is a stereo camera mounted on the body and, the stereo camera includes two cameras.

In an embodiment, the camera includes environmental sensors arranged to detect a position or track the movement of the user or the equipment.

In an embodiment of the first aspect, the apparatus is configured to determine movement of the equipment by applying an object detection and tracking process.

In an embodiment of the first aspect, the activity tracking apparatus further comprises an activity classification engine, the activity classification engine is configured to classify the movement of the equipment and the movement of the user and determine a type of physical activity based on the classified movement.

In an embodiment of the first aspect, the activity tracking apparatus is configured to apply an object tracking process to the captured images, as part of the object tracking process the apparatus is configured to: identify the equipment within the captured images, determine position of the equipment in multiple images, wherein each position denotes a discrete position of the equipment in three-dimensional (3D) space and, determine the movement of the equipment based on the discrete positions of the equipment.

In an embodiment of the first aspect, as part of the object tracking process the apparatus is configured to determine a trajectory of the equipment by analysing the determined discrete position of the equipment across multiple consecutive images and determine the movement of the equipment based on the determined trajectory.

In an embodiment of the first aspect, the apparatus is configured to determine the physical activity being performed based on trajectory of the equipment.

In an embodiment of the first aspect, as part of the object tracking process the apparatus is configured to determine changes in the position of the equipment relative to the user or a user body part in a plurality of consecutive captured images, and the apparatus configured to identify movement of the equipment based on the changes in relative position of the equipment to the user or user body parts.

In an embodiment of the first aspect, the apparatus is configured to identify a physical activity being performed by the user, based on the identified movement of the equipment relative to the user and/or relative to one or more body parts of the user.

In an embodiment of the first aspect, as part of the object tracking process the apparatus is configured:
to identify a reference object within a plurality of captured images, identify the position of equipment relative to the reference object in the plurality of captured images, identify movement of the equipment based on changes in the position of the equipment relative to the reference object in the plurality of captured images.

In an embodiment of the first aspect, the apparatus is configured to determine the type of physical activity being performed by the user based on the movement of the equipment relative to the reference object.

In an embodiment of the first aspect, as part of the object tracking the apparatus is configured to:
determine movement of the equipment relative to the user and relative to the reference object, and;
determine the type of physical activity being performed by the user based on the determined movement of the equipment relative to the user and relative to the reference object.

In an embodiment of the first aspect, the movement of the equipment is determined based on the distance travelled by the equipment and the distance travelled is determined based on the difference in positions of the equipment in multiple captured images.

In an embodiment of the first aspect, the apparatus is configured to:
receive motion data from one or more sensors mounted on the equipment,
process the received motion data to determine movement of the equipment,
identify a physical activity being performed by a user based on the determined movement.

In an embodiment of the first aspect, the apparatus is configured to determine movement of the user by applying a pose estimation process to each of the captured images.

In an embodiment of the first aspect, the apparatus is configured to apply a pose estimation process to the one or more captured images, as part of the pose estimation process the activity tracking apparatus configured to: generate a wire frame model representative of the user body, the wire frame model comprising reference points, the reference points representing joints and/or limbs of the user,
determine movement of the user based on one or more of:
calculating the change in relative angle between two or more predetermined reference points,
calculating the change in angle between one or more predetermined reference points and a reference object,
calculating the change in relative position of a plurality of predetermined reference points.

In an embodiment of the first aspect, the apparatus is configured to calculate a change of a user over multiple captured images and calculate a physical activity performed by a user based on the change, over multiple captured images.

In an embodiment of the first aspect, the apparatus is configured to calculate one or more metrics related the physical activity being performed by the user.

In an embodiment of the first aspect, further comprising a user interface, the user interface configured to present information to a user and/or receive inputs from a user, and the apparatus configured to present via the user interface to a user one or more of:
the type of physical activity being performed,
the one or more metrics regarding the physical activity being performed,
a video stream of the user performing the physical activity,
instructions regarding how to perform a physical activity.

In an embodiment of the first aspect, the one or more metrics comprise one or more of: number of repetitions, quality of the activity, time the activity is performed, work done.

In an embodiment of the first aspect, the activity tracking apparatus further comprises a communication interface, the communication interface configured to allow the apparatus to wirelessly communicate with one or more remote devices or one or more remote platforms, wherein the apparatus is configured to transmit the one or more metrics to a remote device or remote platform via the communication interface.

In an embodiment of the first aspect, the apparatus further comprises an equipment receptacle, the equipment receptacle located on the body and configured to receive and retain one or more types of equipment.

In an embodiment of the first aspect, the apparatus further comprises a code scanner positioned on the body, the code scanner configured to scan a code associated with a user and activate the camera and/or select a predefined physical activity encoded in the code upon successful scanning of the code.

In accordance with a second aspect of the present invention, there is provided an activity tracking apparatus in accordance with claim 1, wherein the apparatus is configured to:
classify the detected movement of the equipment
classify the detected movement of the user
identify a physical activity being performed based on the classification of the movement of the equipment and classification of the movement of the user.

In an embodiment of the second aspect, the apparatus is configured to determine movement of the equipment and the movement of the user by applying an AI model to each of the captured images.

In an embodiment of the second aspect, the apparatus is further configured to determine the movement of the equipment and the movement of the user with one or more environmental sensors arranged to detect a position or track the movement of the user or the equipment.

In an embodiment of the second aspect, the apparatus is configured to process each captured image by a neural network, the neural network being trained to determine the movement of the equipment and the movement of the user and identify the physical activity being performed by the user.

In an embodiment of the second aspect, the apparatus further comprises an activity classification engine configured to implement an:
an object detection module configured to identify and apply the object tracking process,
a pose estimation module configured to identify a user and apply the pose estimation process,
a depth estimation module configured to provide depth information of the equipment and depth information of the user,
the depth information utilised in the object tracking process and pose estimation process to determine the position of the equipment and/or user,
activity analyser that is configured to classify the detected movement of the equipment and the user to identify a type of physical activity being performed.

In an embodiment of the second aspect, the apparatus further comprises: an analytics platform arranged in communication with the activity tracking apparatus, the analytics platform configured to wirelessly receive data from the activity tracking apparatus and/or wirelessly transmit data to the activity tracking apparatus, the analytics platform comprising a processor, a memory unit, and a communication module, wherein the tracking platform is configured to:
receive information regarding the physical activity being performed by the user from the apparatus, generate one or more metrics related to the physical activity, or receive the one or more metrics from the apparatus, display the one or more metrics or transmit the one or more metrics to a user device or a remote device.

The term “image(s)” defines a static image of a subject captured by an image capture device e.g., a camera. The term also defines and covers a body of a video stream of a subject captured by an image capture device e.g., a camera. A video stream comprises multiple bodies, and each body may be considered an image. The term body and image may be used interchangeably within this specification. The term “physical activity” (and variations thereof) means an activity performed by a user. The physical activity may be an exercise or a sport.

### BRIEF DESCRIPTION OF THE DRAWINGS

Embodiments of the present invention will now be described, by way of example, with reference to the accompanying drawings in which:

FIG. 1 illustrates an activity tracking system for tracking performance of the one or more activities by a user;

FIG. 2 illustrates a schematic diagram of an activity tracking apparatus;

FIG. 3 illustrates a schematic diagram of the software architecture of the apparatus of FIG. 1;

FIG. 4 illustrates a process flow diagram of a method 400 for tracking performance of a physical activity;

FIG. 5 illustrates a process flow diagram of another method 400 for tracking performance of a physical activity;

FIG. 6 illustrates a flow chart of an example pose estimation process;

FIG. 7 illustrates a flow chart of an example object tracking process;

FIG. 8 illustrates a flow chart for a method of tracking an activity of a user, using the activity tracking system of FIG. 2;

FIGS. 9 to 11 illustrate the three phases of a squat being performed by the user;

FIGS. 12 to 14 illustrate the three phases of a sit up being performed by a user;

FIG. 15 illustrates an angle of a user's body that is calculated to determine if a sit up has been performed by the apparatus of FIG. 1;

FIG. 16 illustrates one example implementation of the activity classification engine and its architecture for recognising an activity based on at least one angle of a user's body;

FIGS. 17 to 20 illustrate a user performing a lunge;

FIG. 21 illustrates an example implementation of the activity classification engine and architecture to detect an activity based on the relative position of multiple reference points on a wire frame representing the user;

FIGS. 22 to 23 illustrate a user performing a basketball dribble;

FIG. 24 illustrates an example implementation of the activity classification engine and architecture to detect an activity based on the movement of the equipment e.g., a basketball;

FIG. 25 illustrates an example progress tracking screen that is presented to a user on a device.

### DETAILED DESCRIPTION OF THE PREFERRED EMBODIMENTS

Sports and exercise are physical activities that are common hobbies of people. There are several issues faced by people who engage in sports and exercise such as access to coaching, lack of quantifiable data, lack or difficulty in tracking performance and/or progress, difficulty in accessing systematic training programs, as well some of the issues described earlier.

The present invention relates to an activity tracking apparatus and an activity tracking system for training users in one or more physical activities and/or tracking performance of the one or more activities.

In one example the present invention relates to an activity tracking apparatus comprising: a body, a camera mounted on the body. The camera configured to capture one or more images of a user performing a physical activity. The activity tracking apparatus is configured to: capture, by the camera, one or more images of a user performing a physical activity with an equipment, process the one or more captured images and determine movement of the user, process the one or more captured images, and determine movement of the equipment, and identify a physical activity being performed by a user based on the movement of the user and the movement of the equipment.

The apparatus further comprises a processor, a memory unit, a communications interface, and a user interface. The processor and memory unit are disposed within the body. The user interface may comprise at least a display. The user interface may further comprise one or more of a code scanner, a speaker, and a keypad. The processor is electronically coupled to the memory unit, the camera, the communication interface, and the user interface. The processor is configured to: receive one or more images of the user performing a physical activity with an equipment, process the one or more captured images and determine movement of the user, process the one or more captured images, and determine movement of the equipment, and identify a physical activity being performed by a user based on the movement of the user and the movement of the equipment.

The apparatus is configured to calculate one or more metrics that relate to the performance of the physical activity. The metrics may be qualitative or quantitative indicators.

In one example the present invention relates to an activity tracking system comprising: an activity tracking apparatus and an analytics platform. The analytics platform comprising a processor, a memory unit, and a communication module, wherein the tracking platform is configured to: receive information regarding the physical activity being performed by the user, generate one or more metrics related to the physical activity or receive the one or more metrics from the apparatus, display the one or more metrics or transmit the one or more metrics to a user device or a remote device. In an alternative form the analytics platform may receive data regarding the physical activity performed by the user, and the analytics platform is configured to calculate one or more metrics. The metrics may be presented to the user or transmitted to a user device or transmitted to another remote device e.g., the device of a coach or physiotherapist etc.

In a further alternative, the analytics platform may receive the one or more captured images (or video stream) of a person performing a physical activity. The activity platform is configured process the one or more captured images and determine movement of the user, process the one or more captured images, and determine movement of the equipment, and identify a physical activity being performed by a user based on the movement of the user and the movement of the equipment. The processor of the analytics platform may be configured to perform the above-mentioned steps and output the physical activity being performed by the user. In this alternative form, the analytics platform may be configured to calculate one or more metrics related to the physical activity being performed by the user.

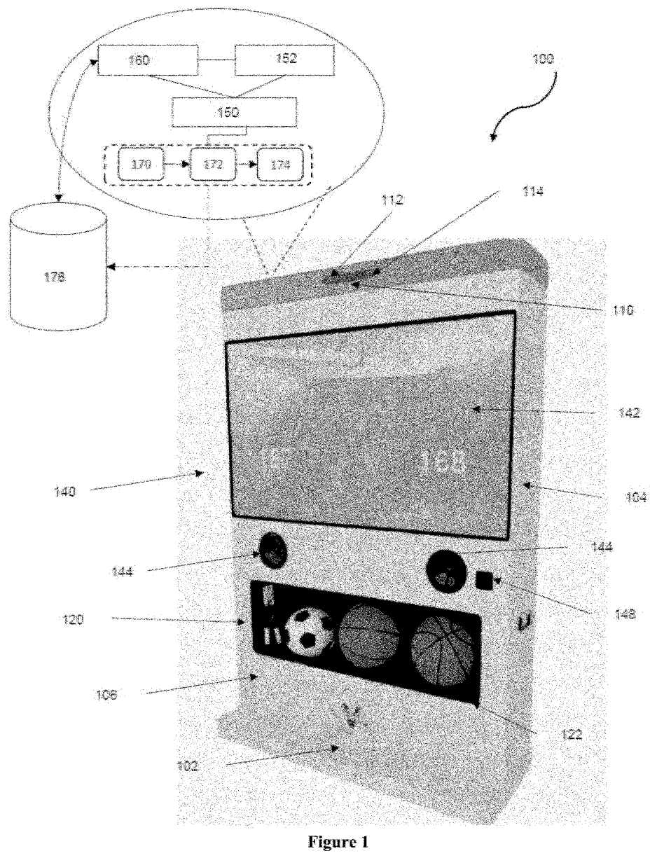

FIG. 1 illustrates an example of an activity tracking apparatus 100 for training users in one or more physical activities and/or tracking performance of the one or more activities. The activity tracking apparatus i.e., activity tracking machine or activity tracking device is utilised by a user (i.e., a person). The activity tracking apparatus 100 (i.e., activity tracking machine) may be used by multiple users. The activity tracking apparatus 100 comprise a base 102 and a body 104 coupled to the base 102. The body 104 and base 102 may be a unitary construction. The apparatus 100 is a free-standing unit as shown in FIG. 1. The activity tracking apparatus 100 may be in the form of a kiosk, as shown in FIG. 1.

The activity tracking apparatus 100 comprises a camera 110 mounted on the body. The camera 110 is mounted on a front face 106 of the body 104 i.e., the use facing side of the body, as shown in FIG. 1. The camera 110 is a stereo camera. The camera comprises a first camera 112 and a second camera 114. The two cameras 112, 114 are spaced apart from each other. The cameras 112, 114 may be mounted on a mount that supports the two cameras 112, 114. The two cameras 112, 114 may be colour cameras configured to capture colour images. The cameras 112, 114 may capture still images or a video stream. The images from the stereo camera 110 can be used to determine a 3D interpretation of the objects and user in the image.

Alternatively, the camera 110 may be a 3D (three dimensional) camera capable of capturing a 3D (three dimensional) image of a scene. In a further alternative the camera 110 or cameras 112, 114 may be black and white cameras configured to capture black and white images. Preferably the apparatus 100 comprises colour cameras.

In another alternative embodiment, the camera 110 may include additional sensors or tracking devices for spatial or object positioning or tracking. Such sensors or devices, which may be referred to as environmental sensors, may include, for example and without limitations, LiDAR units which are capable of detecting users or objects in a 2D plane or 3D space, Time of Flight (ToF) sensors, Ultra-Wideband (UWB) sensors, proximity or distance sensors, ultrasonic sensors, infra-red sensors, pressure sensors, air-pressure sensors, sound or light sensors or other motion sensors. These sensors and devices may be used to detect the presence or position, or track users or objects such as equipment and in turn may provide additional data related to the movement of the users or equipment such as movement timing, movement speed, jump height, etc to track the users or equipment or to be processed so as to assist the processing of images in determining additional or accuracy of tracking data of the users or equipment.

The activity tracking apparatus 100 comprises a user interface 140. The user interface 140 is configured to present information to a user and/or receive inputs from a user. The apparatus 100 is configured to present via the user interface 140 to a user one or more of: the type of physical activity being performed, the one or more metrics regarding the physical activity being performed, a video stream of the user performing the physical activity, instructions regarding how to perform a physical activity.

The user interface 140 may comprise one or more of a display screen, one or more speakers, the code scanner and/or a keypad.

In the illustrated example of FIG. 1, the apparatus 100 comprises a display screen 142, one or more speakers 144 and a keypad and a code scanner 148.

The display screen 142 is of sufficient size such that it is visible from a distance. The display screen 142 may be an LED screen or an LCD screen or any other suitable screen. The display screen 142 may be a touchscreen that allows a user to interact with the display screen and/or input information. The display screen 142 in the illustrated example occupies at least a third of the body 104 of the apparatus 100.

In the illustrated example of FIG. 1, the apparatus 100 comprises two speakers 144 positioned on a front face 106 of the body 104. The speakers 144 are positioned spaced away from each other.

The keypad may be located on the front face 106 of the body 104. The keypad may be used to input information. The keypad may comprise mechanical buttons and/or a dial. In the illustrated embodiment the apparatus 100 does not include a separate keypad. The touchscreen display 142 may be configured to receive inputs. The display 142 may be configured to present virtual buttons or a virtual keypad to allow a user to enter information. The user may be able to select a program e.g., a type of physical activity such as for example an exercise program or a type of sport. The touchscreen 142 also allows a user to input other information e.g., user identity or other related information.

The apparatus 100 comprises a code scanner 148 that is positioned on the body 103. The code scanner 148 is located on the front face of the body 106. The code scanner 148 is a QR code scanner. The user can scan a QR code associated with the user. The code scanner 148 may be a barcode scanner or any other suitable code scanning device.

The activity tracking apparatus 100 (i.e., activity tracking kiosk 100) further comprises an equipment receptacle 120. The equipment receptacle 120 is formed in the body 104 and is configured to retain one or more equipment. In one example the receptacle 120 is a cut out 122 formed in the body. The cut out 122 forms a trough shaped receptacle. The equipment receptacle can retain multiple pieces of equipment.

The equipment may be any equipment used for performing physical activity. Equipment means tools or objects that are used while performing a physical activity. In one example equipment may be exercise tools or implements that a user can utilise for performing exercises. Some examples of exercise equipment are dumbbells, barbells, kettlebells, medicine balls, slam balls, skipping ropes etc. In another example equipment may be sports equipment utilised for sports. Some examples of sports equipment are football, rugby ball, basketball, baseball bat etc.

In one example form the apparatus 100 may comprise a storage bin inside the body. The storage bin provides a space to hold equipment. The storage bin is coupled to the receptacle 120 such that equipment can be dispensed from the storage bin to the receptacle 120. A user may select a specific any activity based on an input via the display 142 or code scanner 148. The apparatus 100 may dispense a specific equipment that is required to perform the selected physical activity. The apparatus 100 may dispense an equipment if the equipment is present. If the equipment is not available an appropriate message may be presented on the display 142.

The activity tracking apparatus 100 further comprises a processor 150 (i.e., a processing unit), including Central Processing United (CPUs), Math Co-Processing Unit (Math Processor), Graphic Processing United (GPUs) or Tensor processing united (TPUs) for tensor or multi-dimensional array calculations or manipulation operations. The apparatus 100 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted, or updated over time. The processor 150 may be capable to operate or to interface with a machine learning network such as for example neural networks to provide functions such as pose estimation to determine movement of the user and object detection and tracking to determine the movement of the equipment. Further neural networks may be utilised to process images captured by the camera to perform object recognition to identify the user and the equipment within each image. The neural network or networks may be trained with appropriate training data to perform these functions.

The activity tracking apparatus 100 may further comprise at least one memory unit 160 e.g., a read-only memory (ROM) and/or a random-access memory (RAM). The memory unit 160 e.g., the ROM may store computer readable instructions that define various functions. The instructions are executable by the processor. The memory unit 160 may comprise multiple software components stored therein defining executable instructions that are executed by the processor to cause the apparatus 100 to perform various functions.

FIG. 1 illustrates one example software architecture of the apparatus 100. FIG. 3 shows a further example software architecture of the apparatus 100. The apparatus 100 comprises an activity classification engine 170. The activity classification engine 170 is configured to identify the type of physical activity being performed by a user based on classification of the movement of the equipment and the movement of the user. The processor 150 is configured to execute instructions that define functions of the activity classification engine 170.

The memory unit 160 may further store instructions that define a data manager module 172 and a graphics rendering engine 174. The data manager module 172 is configured to route data to a database 176 implemented on a memory unit 160. The database 176 may store metrics related to the physical activity performed by the user. The apparatus 100 may comprise multiple databases. In one example the apparatus 100 may comprise a classification database that includes one or more training datasets used to train a neural network used in the activity classification engine 170. The AI model may be executed using the neural network to classify movements of the user and the equipment and identify a physical activity being performed. The processor may further store classified movements in the classification dataset to improve the AI model and better train the neural network. In one example the neural network may be a convolution neural network.

The graphics rendering engine 174 is configured to render a video or a plurality of frames of the user performing a physical activity, and the video or the plurality of frames are presented on the display screen 142. The processor 150 is configured to execute instructions that define the functions of the data manager module 172 and the graphics rendering engine 174.

The activity tracking apparatus 100 comprises a communication interface 152. The communication interface 152 is a wireless communication interface that is configured to connect to a communication network such as for example a Cellular network, Bluetooth, Wi-Fi etc. The communication interface 152 may variously connect to one or more computing devices such as a server, personal computers, terminals, wireless or handheld computing devices, Internet of Things (IoT) devices, smart devices, edge computing devices. The apparatus 100 may comprise a plurality of communication interfaces 152. The one or more communication interfaces 152 may be ICs or chips that provide wireless data transfer capability to the apparatus 100. At least one of a plurality of communication interfaces 152 may be connected to an external computing network through a telephone line or other type of communications link. The apparatus 100 may transmit data wirelessly to a remote device such as an analytics platform 201 or a user device (e.g., a smartphone, tablet, wearable device etc.). Additionally, the apparatus may comprise a further wired communication interface e.g., a USB slot or a serial cable slot that allows another device to link with the apparatus and transfer data.

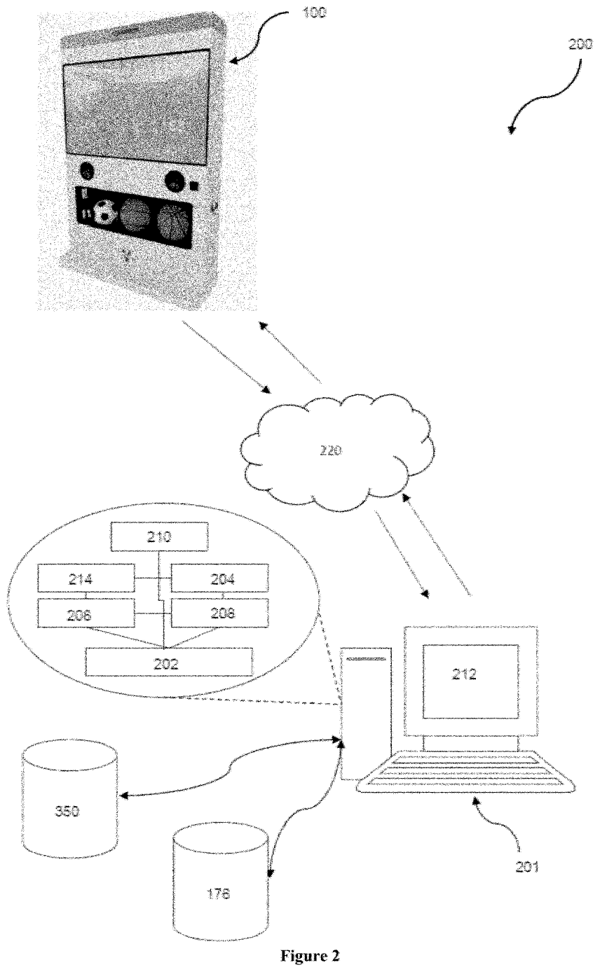

The activity tracking apparatus 100 forms part of an activity tracking system 200 for tracking performance of one or more physical activities performed by the user. FIG. 2 illustrates an example form of an activity tracking system 200. The activity tracking system 200 comprises the activity tracking apparatus 100 as described earlier, and an analytics platform 201. The activity apparatus 100 is configured to communicate with the analytics platform 201 through a communication network 220. The network may be any suitable communication network such as for example a cellular network like 4G or 5G.

The analytics platform 201 is arranged in communication with the activity tracking apparatus 100. The analytics platform 201 is configured to wirelessly receive data and/or transmit data from the activity tracking apparatus 100. The analytics platform 201 is further configured to; receive information regarding the physical activity being performed by the user, generate one or more metrics related to the physical activity or receive the one or more metrics from the apparatus 100, and display the one or more metrics or transmit the one or more metrics to a user device or a remote device.

Referring to FIG. 2 the analytics platform 201 may be in the form of a computer or a server. The computer may be implemented by any computing architecture, including portable computers, tablet computers, stand-alone Personal Computers (PCs), smart devices, Internet of Things (IoT) devices, edge computing devices, client/server architecture, “dumb” terminal/mainbody architecture, cloud-computing based architecture, or any other appropriate architecture. The computing device may be appropriately programmed to implement functions that generate metrics related to the physical activity being performed and display these metrics.

As shown in FIG. 2 there is a shown a schematic diagram of a computer system or computer server that forms the analytics platform 201. In the illustrated example the analytics platform comprises a server 201 which includes suitable components necessary to receive, store and execute appropriate computer instructions. The components may include a processing unit 202, including Central Processing United (CPUs), Math Co-Processing Unit (Math Processor), Graphic Processing United (GPUs) or Tensor processing united (TPUs) for tensor or multi-dimensional array calculations or manipulation operations, read-only memory (ROM) 204, random access memory (RAM) 206. The platform 201 may optionally include input/output devices such as disk drives 208, input devices 210 such as an Ethernet port, a USB port, etc. An optional display 212 such as a liquid crystal display, a light emitting display, or any other suitable display may be provided with the platform 201.

The analytics platform 201 may include instructions that may be included in ROM 204, RAM 206 and may be executed by the processing unit 202. There may be provided a plurality of communication links 214 which may variously connect to the activity tracking apparatus 100 and/or one or more other computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link. The communication links 214 allow the analytics platform server 201 to connect to the activity tracking apparatus 100 and allow wireless data transfer between the platform 201 and the apparatus 100.

The analytics platform 201 may also provide the necessary computational capabilities to operate or to interface with a machine learning network, such as a neural networks, to provide various functions and outputs. The neural network e.g., a convolution neural network may be implemented locally, or it may also be accessible or partially accessible via a server or cloud-based service. The machine learning network may also be untrained, partially trained or fully trained, and/or may also be retrained, adapted, or updated over time.

The analytics platform 201 may be an online platform and the activity tracking apparatus 100 is configured to communicate with the platform via a network. In one example the analytics platform 201 is a server or implemented on a cloud computing system. The system is configured to store the one or more metrics in the memory unit of the analytics platform 201 and wherein the one or more metrics are stored in association with a user identifier that denotes a user.

In an alternative form, the analytics platform 201 may comprise the activity classification engine, data manager module and the graphics rendering engine. The analytics platform may receive images captured by the camera 110 and the analytics platform may be programmed to execute the activity classification engine to process the images, identify movement of the equipment and the movement of the user, classify these movements, and identify the type of physical activity being performed by the user. In this form the analytics platform 201 may render a video of the user performing the identified physical activity and transmit video information to a user device for display.

FIG. 3 illustrates an example software architecture used within the activity tracking apparatus 100. The software components illustrated in FIG. 3 may be implemented by the processor 150 and may be stored as executable instructions within a memory unit of the apparatus 100. Each component shown in FIG. 3 may be in the form of a software program executed by the processor 150.

Referring to FIG. 3, the camera 110 is configured to capture one or more images. In one example the camera 110 is configured to capture a video stream of a scene where a user is performing a physical activity. The camera 110 may comprise interfacing software configured to generate and transmit the captured image.

The apparatus 100 comprises an activity classification engine 170. The activity classification engine 170 is configured to receive captured images from the camera 110. The activity classification engine 170 is configured to identify the equipment and the user in the captured images. The activity classification engine 170 is further configured to determine the movement of the equipment and the user and identify the type of physical activity being performed based on the movement of the equipment and the user. The activity classification engine is configured to generate various physical activity data such as for example the type of physical activity being performed, wire frame models of the user performing an activity, one or more metrics related to the performance of the physical activity and position information regarding the movements of the equipment and the user. Other data may also be generated by the activity classification engine 172.

The apparatus 100 further comprises a data manager module 172 that is arranged in communication with the activity classification engine 170. The data manager module 172 is configured to receive physical activity data (i.e., physical activity information) from the activity classification engine 170. The data manager module 172 is configured to route the received data to one or more databases for storage. In the illustrated example apparatus 100 comprises a metrics database 176 that is configured to store one or more metrics related to the physical activity being performed by the user. In an alternative form, the data manager module 172 may generate the one or more metrics based on physical activity data received from the activity classification engine 170.

The data manager module 172 may categorise or sort data received from the classification engine 170. The data manager module 172 may further tag the activity data or metrics with one or more flags or fields and store in the database 176. Some examples of fields may be the type of activity, the user associated with the detected physical activity, the date, time etc.

The apparatus 100 further comprises a user database 350. The user database 350 stores user information such as for example name, date of birth, height, weight etc. The user database may be populated when a user registers. In one example the user may register at the apparatus (i.e., at the kiosk) and input data via the user interface 140 e.g., by inputting through the screen 142 or scanning a code that includes user information. The user information may also include the specific physical activity the user performs or wants to perform. Alternatively, the user may register and input user information via the platform 201 through a web portal. The platform 201 may be accessible via a web portal at a user device e.g., a smartphone, desktop computer, laptop, tablet etc.

In the illustrated example the activity classification engine 170 comprises a pose estimation module 302, a depth estimation module 304 and an objection detection module 306. These modules feed data into an activity analyser 310. The pose estimation module 302 is configured to process the captured images, identify a user in the captured images and apply a pose estimation process 600. The pose estimation process 600 recognises a pose being performed by the user. The pose estimation process determines the changes in the pose in multiple consecutive captured images and determines movement of the user.

The depth estimation module 304 is configured to determine the depth of the user and the equipment in the captured images. The depth may be determined from the camera focal length if the camera 110 is a 3D camera. In the illustrated embodiment the camera 110 is a stereo camera. The depth estimation module 304 is configured to estimate the depth of each object detected in the images comparing two images captured from each camera 112, 114 and utilising the known spacing of the two cameras 112, 114 and the focal length of each camera. The depth detection module 304 is configured to determine the x and y coordinate of each object recognised in the images from each camera, compare the difference in the x and y coordinate and use the focal length to determine the depth of each object. Preferably an object recognition process is executed at each module 302, 304, 306. Alternatively, the engine 170 may comprise an object detection engine that receives the captured images, performs an object recognition process, and identifies various objects present in the images. The images including the identified objects may be provided to the modules 302, 304, 306.

The objection detection module 306 is configured to perform an object tracking process 700 on the captured images. The object tracking process is configured to identify the equipment in the received images and determine movement of the equipment. The object tracking process 700 further determines movement of the equipment relative to the user and/or a reference object.

The activity analyser 310 is configured to receive information from the object detection module 306, the depth estimation module 304 and the pose estimation module 302. The activity analyser is configured to classify the detected movement of the equipment and the user to identify the type of physical activity being performed by the user. The activity analyser 310 may compare the detected movement with activity reference movements that are representative of specific physical activity e.g., sport or exercises. Some examples of activity that may be identified are a user performing squats, lunges, dribbling a basketball, kettlebell swings, deadlifts etc.

Optionally, the apparatus 100 may comprise activity reference movements stored in the reference movement database 308. The reference movement database 308 may provide reference movements to the activity analyser to perform classification of the detected movements.

The pose estimation module 302 and the object detection module 306 apply an AI model 340. The AI model may use perform pose estimation and object tracking. In one example the AI model is used for the object tracking process. The AI model may comprise or be used with a neural network for performing the object tracking process. The AI model may also be used to implement the pose estimation process.

The apparatus may comprise an AI training system 342 that is configured to house training data sets. The training data sets are used to train and tune the AI model. The AI training system 342 is coupled to receive detected physical activity data from the database 176 and/or also receive data from reference movement database 308. The training system 342 may periodically update the training dataset and update the AI model to improve the accuracy and functioning of the AI model. The apparatus further comprises an annotation module 344. The annotation module is configured to annotate data from the databases 176 or 308. The annotation module is configured to annotate data with appropriate fields for use as part of the training data set.

The apparatus further comprises a metrics engine 330. The metrics engine 330 is configured generate one or more metrics related to the physical activity being performed by the user. The metrics may be quantitative or qualitative metrics. For example, the quantitative metrics may comprise one or more of number of exercises performed or number of basketball dribbles or number of football juggles etc. The metrics engine 330 is programmed to generate any suitable metrics. The metrics engine may be part of the data manager module 172. Alternatively, the metrics engine 330 may be part of the analytics classification engine 170 or may be a separate software component. The metrics engine 330 may be configured to transmit metrics to the database 176 and store data in the database 176.

The metrics engine 330 may be configured to generate qualitative metrics such as range of motion of an exercise or quality of reps or quality of basketball dribbles or level of control of a football etc. The metrics engine 330 may comprise an AI tracker that is configured to recognise or generate qualitative or quantitative metrics. The AI tracker may implement metrics generation algorithms to generate one or more metrics and track these metrics from the data.

These qualitative and quantitative metrics may be transmitted or presented to a user device 334 via a web portal 332. The web portal may be hosted by the platform 201. The web portal provides a user device 334 access to the platform 201. Alternatively, the user device 334 may be able to access the apparatus via the web portal 332. The metrics from the metrics engine are presented to the user on the user device 334.

The graphics rendering engine 174 is configured to render a video or a plurality of frames of the user performing a physical activity, and the video or the plurality of frames are presented on the display screen 142. The graphics rendering engine 174 may generate and overlay a wire frame model on to the user in the video. Additionally, or alternatively, the graphics rendering engine 174 may render or generate a model illustrating the best technique. The model allows a user to see how the best way a physical activity should be performed. This can be used for coaching or improvement of a user's performance. The graphics rendering engine 174 may further render metrics for display on the screen 142.

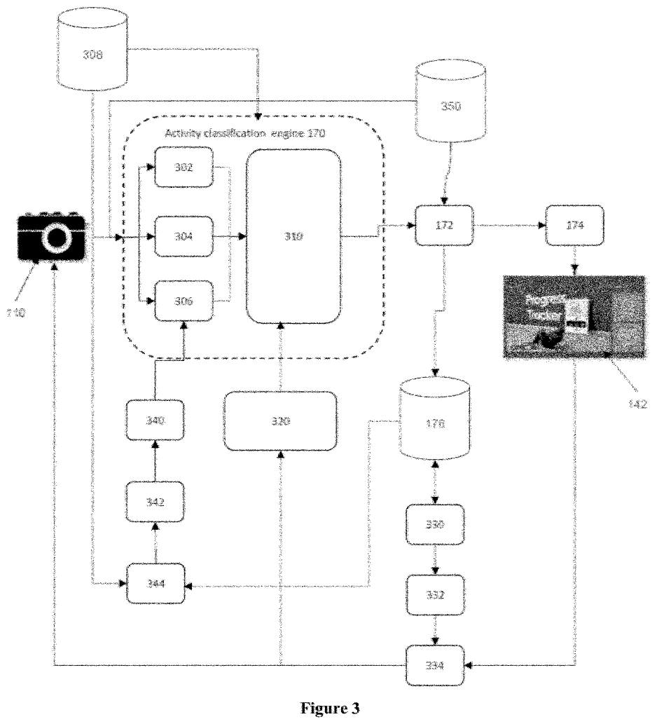

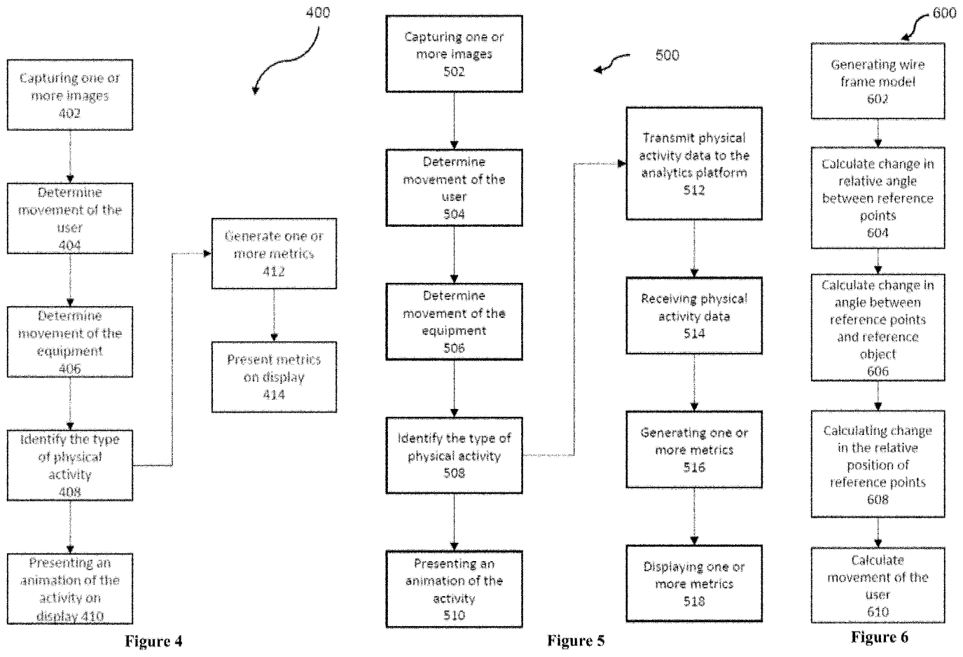

FIG. 4 illustrates a process flow diagram of a method 400 for tracking performance of a physical activity being performed by a user or multiple users. The method 400 may be executed by the apparatus 100. The method comprises the step 402. Step 402 comprises the step of capturing, by the camera, one or more images of the user performing a physical activity with an equipment. Step 404 comprises processing the one or more captured images and determine movement of the user from the captured images. Step 406 comprises processing the one or more captured images an determine movement of the equipment. Steps 404 and 406 may be performed in parallel. Step 408 comprises the step of identifying the type of physical activity being performed by a user based on the movement of the equipment and the movement of the user. The method comprises the step of presenting an animation 410 of the user performing a physical activity on a display 142. The steps of determining the movement are carried out across multiple, consecutive images or video frames. The movement of the equipment and user is determined based on the position of each in consecutive images. The method 400 may be repeated.

The method may comprise the optional steps of generating one or more metrics related to the physical activity 412 and present the metrics on a display 414.

The method 400 is performed by the apparatus. In particular, the method 400 is performed by the processor of the apparatus and utilises the various software modules illustrated in FIG. 3.

FIG. 5 illustrates a further example method 500 for tracking performance of a physical activity by a user. The method is executed by the activity tracking system. The method commences on step 502. Step 502 comprises the step of capturing, by the camera, one or more images of the user performing a physical activity with an equipment. Step 504 comprises processing the one or more captured images and determine movement of the user from the captured images. Step 506 comprises processing the one or more captured images an determine movement of the equipment. Steps 504 and 506 may be performed in parallel. Step 508 comprises the step of identifying the type of physical activity being performed by a user based on the movement of the equipment and the movement of the user. The method comprises the step of presenting an animation 510 of the user performing a physical activity on a display 142. Step 510 may be optional.

The method 500 comprises the step 512 of transmitting the physical activity data to an analytics platform 201. Step 512 may be performed in parallel to step 510. The method comprises the step 514 of receiving information regarding the physical activity (i.e., physical activity data) being performed by the user from the apparatus. Step 516 comprises generating one or more metrics related to the physical activity. Alternatively, step 516 may comprise receiving one or more metrics from the apparatus. Step 518 comprises displaying the one or more metrics (i.e., presenting one or more metrics). The metrics may be displayed to a user via the web portal 332. The web portal may present the metrics on a user device 334 via the web portal 332. The method 500 is performed by the system 200.

FIG. 6 illustrates a flow chart of an example pose estimation process 600. The pose estimation process 600 may be sub routine part of the method for tracking performance of a physical activity. The pose estimation process 600 is a sub-routine as part of step 404 or step 504 (i.e., the step of determining the movement of the user). The pose estimation process is used to determine the position of the user and determine the movement of the user based on position estimation.

The pose estimation process comprises step 602. Step 602 comprises generating a wire frame model representative of the user body. The wire frame model comprises one or more reference points. Step 602 also comprises determining the position of the reference points e.g., in a coordinate system. The reference points of the wire frame model (i.e., a skeleton frame) represent joints and limbs of the user. The wire frame model comprises limbs and joints that approximate the position and size of limbs and position and orientation of the user's joints. The wire frame model represents all major limbs and joints of the user e.g., kneed joints, elbow joints, hip joints, arms, and legs.

Step 604 comprises calculating the change in the relative angle between two or more predetermined reference points. The change in angle may be calculated based on the coordinates of the reference points e.g., limbs and joints. Step 606 comprises calculating the change in the angle between one or more predetermined reference points (e.g., limbs and joints) and a reference object e.g., the floor. Step 608 calculating the change in the relative position of the plurality of predetermined reference points. The change in position can be calculated based on the coordinates of the reference points over multiple, consecutive images.

The apparatus is configured to calculate a change of a user over multiple captured images and calculate a physical activity performed by a user based on the change across multiple captured images. The pose estimation is performed on multiple consecutive captured images to determine the movement of the user.

The apparatus 100 is configured to perform the pose estimation process for multiple users. The activity apparatus 100 can be used with a single user or multiple users. The activity apparatus 100 may be configured to identify a physical activity being performed by multiple people by applying the tracking performance of a physical activity (e.g., method 400 or method 500)

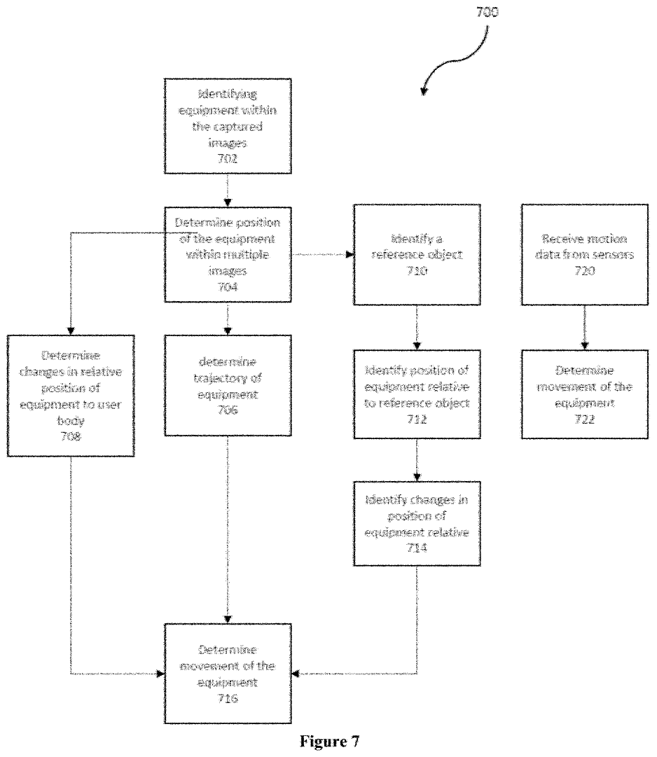

FIG. 7 illustrates a flow chart of an example object tracking process 700. The object tracking process 700 may be a sub routine that is part of the method for tracking. The object tracking process 700 is used to determine the movement of the equipment. The object tracking process may be applied as part of step 406 or 506.

The object tracking process 700 comprises step 702. Step 702 comprises identifying the equipment within the captured image. Step 704 comprises determining position of the equipment in the captured image i.e., in the multiple images. Each position denotes a discrete position of the equipment in three-dimensional space.

Step 706 comprises determining trajectory of the equipment by analysing the determined discrete position of the equipment across multiple consecutive images. Step 708 comprises determining changes in the position of the equipment relative to the user or a user body part in a plurality of consecutive captured images.

Step 710 comprises identifying a reference object within a plurality of captured images. Step 712 comprises identifying the position of equipment relative to the reference object in the plurality of captured images. The plurality of images may be consecutive captured images. Step 714 comprises identifying the changes in the position of the equipment relative to the reference object.

Step 716 comprises determining the movement of the equipment. The movement of the equipment is determined based on the determined trajectory. In another example the movement of the equipment is based on the change in position and the trajectory of the equipment. The apparatus 100 may be configured to determine the type of physical activity being performed by the user based on the determined trajectory of the equipment. Additionally, or alternatively, the movement of the equipment is determined based on changes in the position of the equipment relative to the reference object in the plurality of captured images. Additionally, or alternatively the movement of the equipment is determined based on the changes in relative position of the equipment to the user or user body parts

In another option the apparatus is configured to determine the movement of the equipment is determined based on the distance travelled by the equipment and the distance travelled is determined based on the difference in positions of the equipment in multiple captured images

The steps of method 700 are implemented by the apparatus. More specifically, the processor 150 is configured to implement the steps of method 700 using the software modules in FIG. 3. The module 306 may comprise computer executable instructions that when executed cause the processor 150 to perform the steps of method 700.

The equipment may comprise one or more sensors. For example, the equipment that is used with the activity tracking apparatus may include one or more integrated sensors or may include a separate sensor that is removably coupled to the equipment. The one or more sensors may be any suitable sensors that measure movement of the equipment. The one or more sensors may further comprise a sensor that is configured to generate measurements that can be used to generate metrics. The one or more sensors are preferably wireless sensors configured to wirelessly communicate with the apparatus. The one or more sensors are configured to wirelessly transmit sensor data to the apparatus for processing by the processor 150. In one example the sensors may transmit data via Bluetooth and include a Bluetooth communication module. The one or more sensors may comprise an accelerometer and a gyroscope.

The method 700 may comprise the additional steps associated with determining movement of the equipment based on received sensor data. Step 720 comprises receiving motion data from one or more sensors mounted on the equipment. Motion data denotes data captured by a sensor configured to measure motion of the equipment e.g., an accelerometer. Step 722 comprises processing the received motion data to determine movement of the equipment. The type of physical activity is calculated by classifying the movement of the equipment. Optionally the object tracking process 700 comprise all the steps 702 to 722. The object tracking process may process images of the equipment and motion data from sensors in conjunction to identify movement of the equipment.

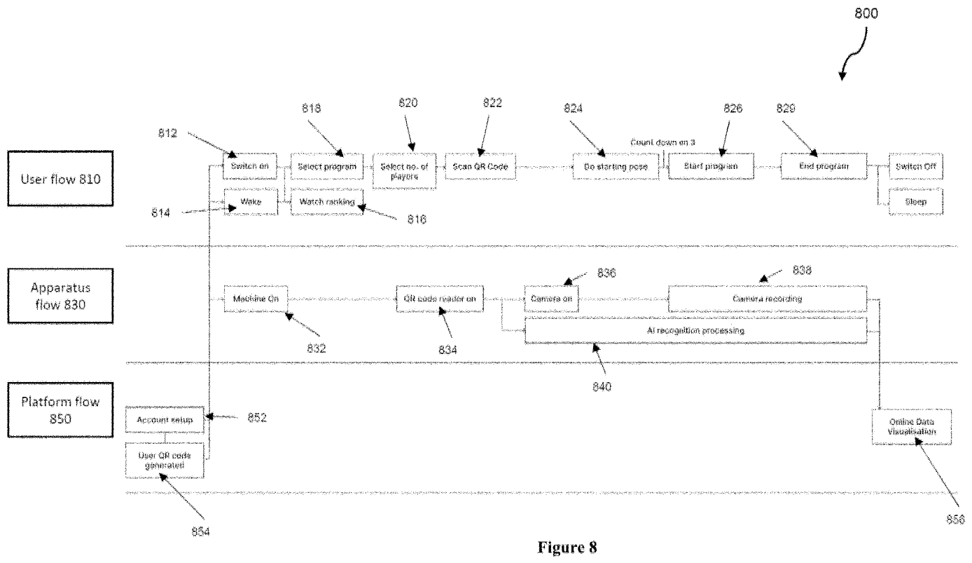

FIG. 8 illustrates a flow chart for a method of tracking an activity of a user 800 using the activity tracking system 200. FIG. 8 shows the steps a user performs when using the activity tracking apparatus and an activity tracking system.

Referring to FIG. 8, the platform flow 850 illustrates the steps the analytics platform 201. Step 852 comprises setting up a user account. The user can access the platform 201 and set up an account. The user information may be stored in the user database 350. Step 854 comprises the analytics platform 201 may generate a code e.g., a QR code that is associated with the user. The QR code may be encoded with user information and may further include a specific physical activity that a user may want to perform. Step 856 comprises the step of receiving data from the platform and providing visualisation via the platform 201.

Visualisation may comprise displaying a visual recording or a visual representation of the user performing an activity. The type of activity may be displayed. One or more metrics related to the performance of the user may be presented. The analytics platform 201 may further generate coaching tips about the activity and present these to the user. The coaching tips may relate to how a user can improve their performance. The activity platform may store the user's performance records such that these can be accessed by a coach, or another interested party. The training records may comprise the metrics. Multiple training records may be stored to track performance over a set time.

Referring to FIG. 8, the user flow 810 illustrates the steps a user performs while using the activity tracking apparatus 100 and system 200. The user switches on the activity tracking machine at step 812. Step 814 may optionally comprise waking the tracking apparatus i.e., activity tracking machine 100 from a standby state. The user or users may watch the rankings at step 816. The rankings may be determined from the metrics that have been gathered. The rankings may be calculated at the platform 201 or at the apparatus 100.

Step 818 comprises selecting a program. The program may correspond to a specific activity the user wishes to perform. For example, the selected program may relate to a specific sport or exercise. Step 820 comprises selecting the number of players for the activity. The selected program and the number of players may be inputted to the apparatus 100. Step 822 comprises scanning the QR code. Step 824 comprises calibrating the apparatus 100. Step 824 may comprise the user (or users) doing a pose once the camera has been switched on. The pose is done and held for a period e.g., 3 seconds. The apparatus may perform pose estimation and object tracking to calibrate the camera. Step 826 comprises starting the program i.e., the user performs the program. The program may also define a specific exercise program e.g., 10 kettlebell swings. Step 829 comprises ending the program. Once the program is ended the apparatus may either be switched off or “sleep” i.e., enter a standby mode.

The apparatus may store a plurality of pre-defined sport or exercise programs. Some examples are squats, lunges, skipping, kettlebell exercises, barbell exercises, basketball dribbles and other similar programs. The apparatus may comprise a program selectin module that may be configured to allow a user to select an exercise program or a sport specific training program. The user selection may be displayed, and the apparatus may track user performance and provide feedback. In an alternative form, the program may be encoded in the QR code. Scanning of the QR code may present the user with a notification of a selected program. Upon confirmation from the user, the apparatus 100 may begin the program and provide feedback based on determining how well a user performs the activity.

FIG. 8 also illustrates the step of the apparatus flow 830. The apparatus flow 830 illustrates steps the apparatus performs when used. Referring to FIG. 8, step 832 comprises switching on the activity tracking apparatus 100 (i.e., activity tracking machine). Step 834 comprises switching on the QR code reader and scanning the code. The code being scanned may identify the specific activity the user wants to perform. The apparatus may load (i.e., enable) specific software modules within the activity classification engine to identify the activity identified in the QR code. Step 836 comprises switching on the camera and performing the calibration as described earlier. Step 838 comprises recording the user performing the activity. The whole activity performance may be recorded. Step 840 comprises AI recognition of the activity. The AI recognition defines using the software system described in FIG. 3 and applying the method for tracking performance of an activity. The method may comprise using an AI model to identify the activity being performed. The images captured by the camera may be performed in real time by the AI based activity classification engine. Alternatively, the images may be stored in the memory of the apparatus 100 and the AI based activity classification may be performed after the recording is stored. The activity data may be transmitted to the analytics platform 201 for further processing and visualisation.

FIGS. 9 to 15, 17 to 20 and FIGS. 22 to 23 illustrate examples of various physical activities being performed by a user. These figures illustrate the activity identification process.

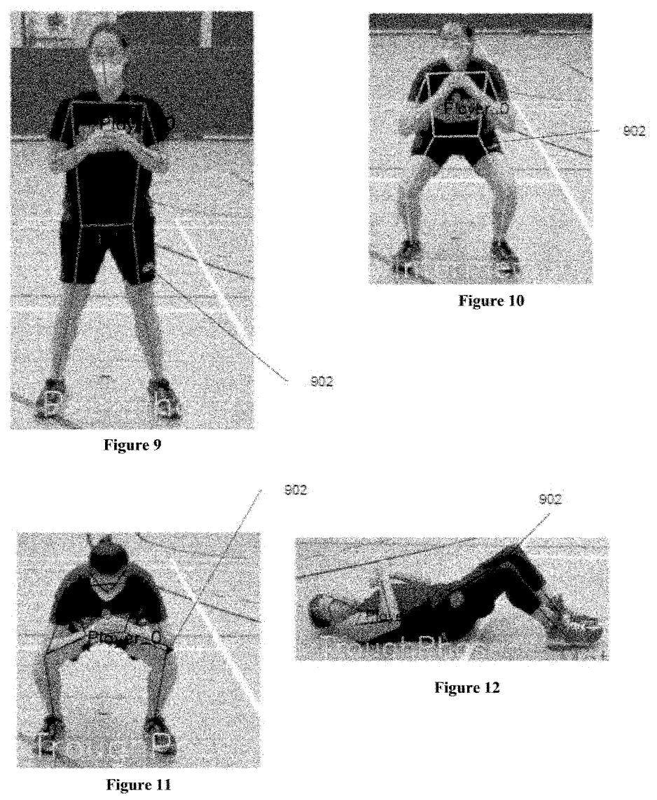

FIGS. 9 to 11 illustrate images captured by the camera 110 of a user performing squats. The images are captured, and a pose estimation process is executed. The position of the user is determined in each image. FIG. 9 illustrates a wire frame model 902 being overlaid over the user. The wire frame model 902 includes joints and limbs as shown in FIGS. 9 to 11. The squat motion is divided into three phases. FIG. 9 illustrates the “peak phase” that corresponds to a user standing straight up. FIG. 10 illustrates the “intermediate phase” that is part way between a full squat and the peak phase. FIG. 11 illustrates the “trough phase” i.e., the full squat position.

The apparatus 100 is configured to detect each of the user pose by calculating the position of the user based on the coordinates of the limbs and joints of the wire frame. The apparatus is configured to apply the pose estimation process 600 as described earlier. The angles between reference points i.e., joints and limbs are calculated by the apparatus. Each position of the squat is determined based on the change in the angles between reference points. In the illustrated example the angle of the knee joint is calculated, and the angle of the hip joint may be calculated. The apparatus is further configured to calculate the change in angle between one or more joints and a reference object e.g., the floor. In this example the apparatus may calculate the angle between the hips or thigh to the floor, and optionally the knee to the floor. As part of the pose estimation process the relative position of the reference points is calculated i.e., the relative position of the hips to the feet, the relative position of the thighs to the shin and the relative position of the knees may all be used to determine the phases. The apparatus is further configured to track the repeated phases of the user's movement. The pose estimation process provides an output of the movement of the user.

Several activities e.g., exercises have repeated movements. The pose estimation process may further determine repeated phases i.e., repeated positions the user moves through. The activity can be classified based on interpreting the phases of movement and the position in each phase. The movement of the user is classified to identify an activity. In the illustrated FIGS. 9 to 11 the three repeated phases are detected based on pose estimation at each phase. The repeated phases and pose of the user in each phase are classified to be a squat. The number of squats performed by the user may be counted and presented on the display or transmitted to the analytics platform for further processing. The analytics platform may determine one or more of the quality of each rep, number of reps, faults, or improvements in the squat. This information can be stored in association with a user's profile or transmitted to a remote device e.g., a coach's device or displayed to a user.

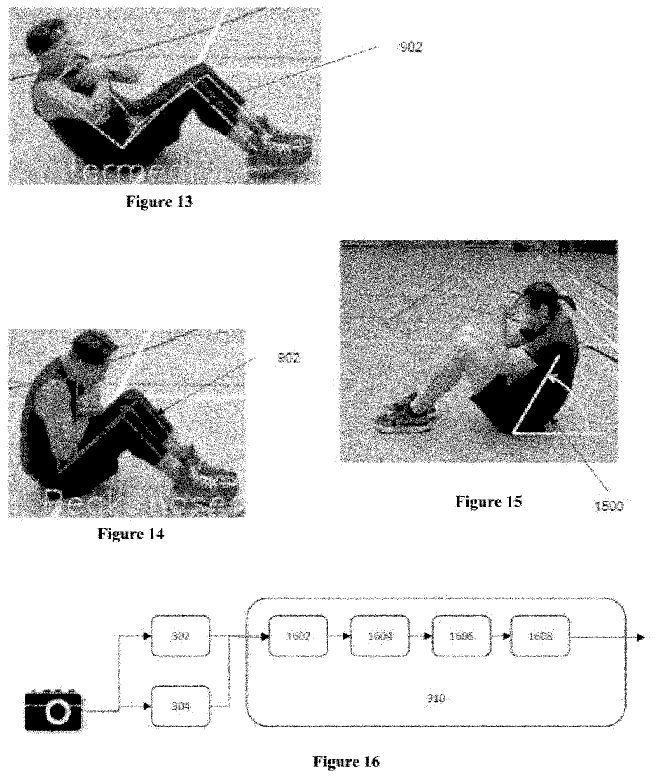

FIGS. 12 to 14 illustrate a user performing a sit up. The user moves through three phases in a sit up. FIG. 12 illustrates the through phase i.e., when the user is lying flat. FIG. 13 illustrates the intermediate position. FIG. 14 illustrates the peak phase i.e., when the user is sitting up. The wire frame model is overlaid over the image. The pose estimation process as described herein can be applied to each of the captured images e.g., FIGS. 12 to 14. FIG. 15 illustrates an example of an angle that is determined between reference points and a reference object during the pose estimation process. Referring to FIG. 15, the angle 1500 (i.e., angle between the torso and the floor) is one example angle that is determined. The angle 1500 may be determined based on the wire frame model 902. In one example this may be the only angle that is determined. The angle denotes the position of the user. For example, a substantially 0 degree angle denotes the trough phase. An approximately 30-45 degree angle denotes the intermediate phase and an angle above 60 degree denotes a peak phase. The angle and phases are used to classify the activity being performed.

The angles and positions of a user via the pose estimation process may also be used to determine one or more metrics. For example, the quality of a sit up rep may be determined by the angle 1500 at the peak phase. The apparatus 100 or platform 201 may be configured to determine if a user has performed a full sit up i.e., if the sit up is a complete sit up. Similar information may be used in assessing the quality of a squat.

FIG. 16 illustrates one example of the activity classification engine and its architecture for recognising an activity based on at least one angle of a user's body. FIG. 16 illustrates one example implementation of the activity classification engine 310 and its software components. The configuration illustrated in FIG. 16 illustrates some software modules that are configured to detect an exercise that has repeated movements and uses angles between one or more reference points to determine the movement of the user. Referring to FIG. 16, the activity analyser comprises an angle extractor 1602, an angle analyser 1604, a temporal analyser 1606 and a scoring module 1608. The software modules 1602 to 1608 may be part of the activity analyser 310 or may be part of the pose estimation module 302.

The image may be processed by the pose estimation module 302 and the depth estimation module 304. The position information and depth information may be processed by the angle extractor 1602 that is configured to calculate one or more angles between reference points. The angle extractor 1602 may also calculate angles between reference points and a reference object. The angle analyser 1604 is configured to calculate the angles. The angle analyser 1604 may also be configured to calculate the change in some angles e.g., for a sit up the angle of the hip 1500. The temporal analyser 1606 is configured to analyse the time lapse of the various images. The temporal analyser 1606 may be configured to arrange the images and recognised poses in the correct temporal order. This may be done based on the time stamp of each image for example. The scoring module 1608 is configured to score the pose estimation process and provide a confidence regarding the detection of the movement of the user. The score may relate to the accuracy of the pose estimation and movement identification. If the score is below a predefined passing score the movement output (and/or pose estimation output) may be rejected. The detected movement (and/or poses) that pass are used in classification of the movement to determine the activity being performed. The scoring module 1608 may optionally determine one or more metrics related to the activity being performed.

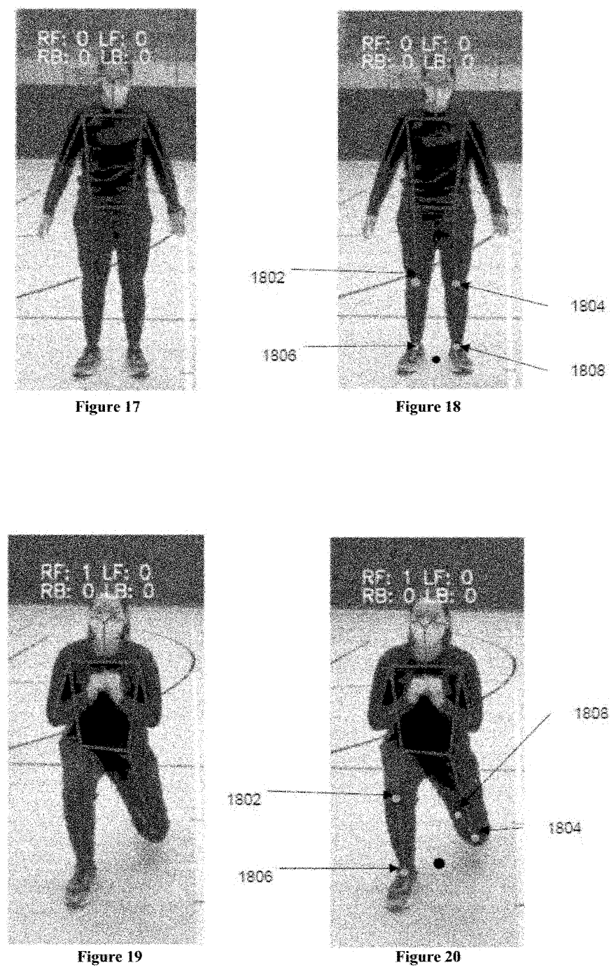

FIGS. 17 to 20 illustrate another example of pose estimation to determine movement of the user. FIGS. 17 to 20 illustrate images captured of a user performing a lunge. Detection of a lunge depends on the three-dimensional human pose and change in the pose. For a lunge a similar pose estimation process as above may be used where angles of one or more limbs are determined. However, alternatively, as shown in FIGS. 18 and 20 the change in position of reference points is used to determine the movement of the user and determine the activity. FIGS. 17 and 19 illustrate the two positions of a lunge i.e., the peak position and a trough position respectively. The peak position relates to a person standing and trough relates to the bottom of the lunge.

Referring to FIGS. 17 to 20 the activity classification engine 310 is configured to determine the position of specific reference points and the change in position of the reference points, as part of pose estimation. As shown in FIGS. 18 and 20 the position of the knee joints and ankle joints is detected in multiple consecutive images. The engine 310 determines a peak position by comparing the position of the two knees 1802, 1804 relative to each other and the ankles 1806, 1808 relative to each other. The trough position is by comparing the relative positions and the change in the position of the knees and ankles. As seen in FIG. 20 one knee 1804 and one ankle 1808 are lower relative to the corresponding knee 1802 and ankle 1806. Further one ankle is located deeper relative to the other ankle. Additionally, the movement from a first position to a second position for the knee and ankle may be calculated. The engine 310 may be configured to detect the repetition of movement of the knees and ankles to count reps of the lunges.

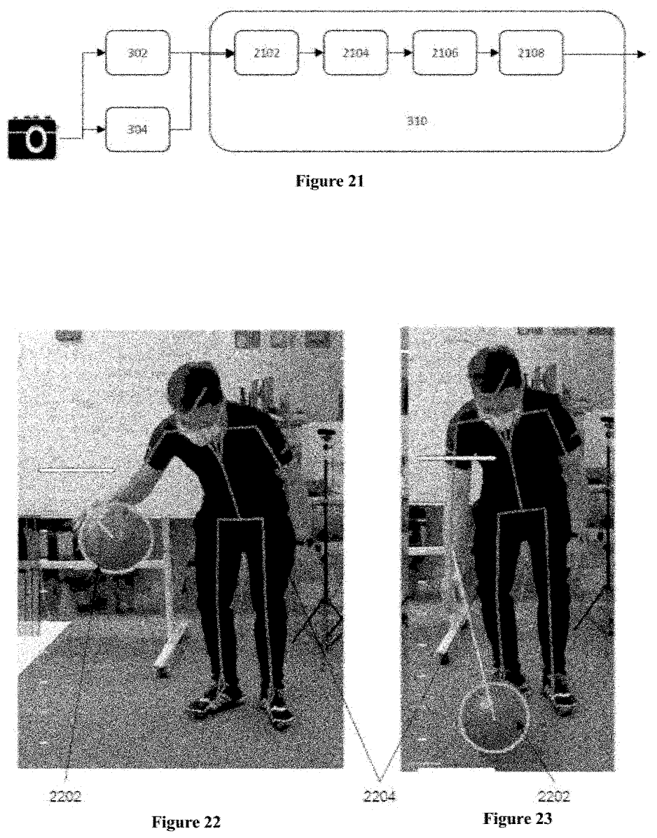

FIG. 21 illustrates an example implementation of the activity classification engine and architecture to detect an activity based on the relative position of multiple reference points. The apparatus may comprise a key point extractor module 2102. The key point extractor receives data from the pose estimation module 302 and the depth module 304. The key point extractor module may identify the positions of specific reference points. The reference points may be selected based on the selected program by the user. Alternatively, the key point extractor may identify the key points (i.e., reference points) based on a defined program when the QR code is scanned.

The engine 310 comprises a key point analyser module 2104. The key point analyser module 2104 is configured to determine the movement of the specified reference points (i.e., key points) and/or the relative position of the reference points. The key point analyser may utilise an AI algorithm to determine the change in position or change in relative position based on the coordinate measures of the reference points. The temporal analyser module 2106 is configured to analyse the time lapse of the various images. The temporal analyser 2106 may be configured to arrange the images and recognised poses in the correct temporal order. This may be done based on the time stamp of each image for example. The temporal analyser module 2106 may identify the temporal movement of the reference points. The scoring module 2108 is configured to score the pose estimation process and provide a confidence regarding the detection of the movement of the user based on the change in the position of reference points. The scoring module 2108 may function in a similar manner as described earlier. The scoring module 2108 will provide a confidence score regarding the confidence of the detected positions and change in positions of reference points. This data is used to output a movement of the user e.g., movement of a leg during a lunge.

FIGS. 22 and 23 illustrate the activity detection process to detect a basketball dribble i.e., bouncing a basketball. The apparatus is configured to detect the position of the equipment, the change in the position of the equipment and the relative position of the equipment to a reference object and/or reference body parts. The apparatus may also calculate the trajectory of the equipment e.g., the basketball in FIGS. 22 and 23 based on the changes in position of the basketball. The ball 2202 is identified in the images. The user 2204 is identified in the images. The position of the ball relative to the hand of the user and the floor is determined. The changes in the ball position are detected. These positions and changes are calculated over multiple images to determine the trajectory and movement of the ball 2202.

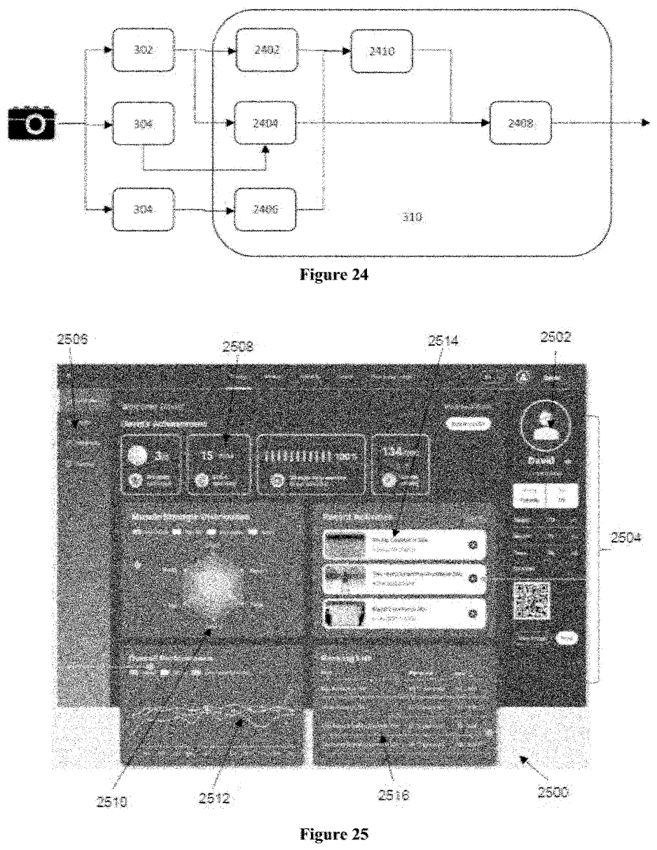

In one example the activity classification engine may comprise a plurality of modules (i.e., applications), executable by the processor 150, to detect the movement of the equipment. The modules are used by the process to perform the object tracking process. Referring to FIG. 24, the engine 310 comprises a floor detection module 2402, a hand detection module 2404, a ball tracker module 2406 and a bounce detection module 2408. The floor detection module 2402 is configured to infer the position of the floor based on the detected position of the user's feet from the pose estimation module 302.

The hand detection module 2404 is configured to link the hand with the ball i.e., the relative position of the ball to the hand is determined by using the output of the ball tracker module 2406, the position of the hand from the pose estimation module 302 and the depth data from the depth estimation module 304. The position of the ball relative to the hand may be defined as coordinates in a coordinate system. All positions of the user and equipment may be defined by appropriate coordinates in a coordinate system.

The ball tracker module 2406 is configured to receive output from the objection detection module 306. The object detection module is configured to perform the object tracking process. The ball tracker module may be configured to calculate the position of the ball in each frame (i.e., each image). The ball tracker module 2406 may further calculate the change in the position of the ball and determine the trajectory of the ball 2206. The trajectory 2206 is illustrated in FIG. 23. The trajectory can be used to determine the movement of the ball. The ball tracker module may be part of the object detection module 306.

The bounce detection module 2410 is configured to determine the movement of the ball. In the illustrated embodiment the bounce detection module 2410 is configured to detect if the ball has been bounced based on the output from the ball tracker module 2406 and the floor detection module 2402. The relative position of the floor is used with the positions of the ball to calculate the distance of the ball from the floor. The bounce can be classified based on these outputs. Additional complex dribbles can be calculated based on the trajectory of the ball, changes in ball positions, the association of the ball relative to the hand, speed of the ball (calculated from changes in position) and the position of the ball relative to the floor. All these inputs may be used to classify the type and/or quality of the dribbles.

The scoring module 2408 is configured to score the dribbles and determine the confidence that a dribble has been detected. The scoring module 2408 may discard the dribbles that are below a confidence threshold. The scoring module 2408 may also calculate specific metrics related to the basketball dribbles. The classification engine 310 may be configured to determine the movement of the ball and then classify the physical activity based on the movement of the ball. In this example the movement of the ball relates to determining basketball dribbles and the activity identified is basketball. The illustrated example performs activity identification for a single user, but this could be performed for multiple users.

The modules as described in FIGS. 16, 21 and 24 are examples only. The activity tracking apparatus 100 may comprise additional modules or different modules. The general software architecture is illustrated in FIG. 3, however specific or custom modules may be included. The modules described herein are described as software modules but may alternatively be firmware modules or hardware modules such as for example chips or ICs or a combination of software and hardware modules.

FIG. 25 illustrates an example progress tracking screen 2500. The progress tracking screen 2500 may be presented on the display 142 of the apparatus. Alternatively, the progress tracking screen may be presented via the web portal 332 on the online platform 201.

Referring to FIG. 25, the progress tracking screen may include multiple data. The tracking screen 2500 includes the user's name and a photo 2502. The screen 2500 presents user data 2504 including at least weight and height. In the illustrated example, age, sex, weight, height and QR code are included in the user data 2504. There is presented a selection menu 2506 that allows a user to select programs as well as perform other functions such as modify settings, see an overview screen etc. The present screen 2500 is an overview screen.

The screen further comprises achievements 2508. These achievements may be calculated on the analytics platform 201 based on the metrics of the user. The metrics may be compared to predefined performance goals and predefined achievements may be displayed to the user. Optionally as part of the achievements tab an overall score may be presented. The score may be calculated by comparing the current user's metrics for a specific activity with the metrics of other users. The score may denote a comparative ranking of the user.

The progress tracking screen 2500 may further present a physiological parameter plot 2510. In the illustrated example of FIG. 25, the plot is a surface plot of the muscle strength determined for various muscle groups. The muscle strength may be calculated from the performance of the activity and the metrics of that activity. For example, if the activity was push ups, the larger the number of push ups performed over time the more muscle strength in the arms and chest. Optionally, the apparatus may determine quality of the performance the physiological parameter may be calculated from a qualitative measure e.g., qualitative metrics may be used to determine the physiological parameter.

The screen 2500 is configured to present a data visualisation screen 2512. The data visualisation screen 2512 may present graphical representations of activity performance. The graphical representation may include any suitable graph. In the illustrated example multiple activities (e.g., squat, sit up and one-handed dribble) are plotted across months. The graphs indicate the cumulative reps performed for each month. The time series graphs allow a user or a coach to assess performance over a period.

The screen 2500 may provide a video showcase 2514. The video showcase is a region where available videos are presented to the user. These videos may be coaching videos or technique videos that can be used to help coach the user. Alternatively, the videos may be video recordings of the user performing the activity. The screen 2500 may also present a ranking list 2516. The ranking list may show rankings of the user in the user's age group for a specific activity. The change in rank may also be illustrated. The rank of the user can be calculated for any context e.g., compared to classmates, or all people in the user's age group etc. The screen 2500 is advantageous as it presents several useful data for a coach to assess performance and design a program. The data also facilitates a user to self-improve.

The activity tracking apparatus 100 as described herein provides a free-standing machine that automatically determines the type of activity being performed by analysing captured images of a user performing the activity. The apparatus 100 is advantageous it uses AI technology for smart action detection and activity identification. The apparatus utilises an AI model to detect the activity being performed which allows a substantially real time operation as opposed to another person reviewing video or images. The apparatus 100 presents a recording of the user and may generate coaching (i.e., improvement) tips and suggestions that are presented to the user. The apparatus 100 and system 200 allow for smart training of a user. It empowers a user to engage in physical activity and get feedback and track performance.

The apparatus 100 and system 200 are further advantageous since they create retrievable records of various activity related metrics. The data is quantified, and metrics generated are advantageous since they facilitate activity performance analysis e.g., sports performance analysis. The system 200 allows for review and progress tracking since data is stored in a record. The apparatus 100 is advantageous since it allows real time feedback and analysis of the user performance and thus allow for a customized exercise program for an individual user. The apparatus 100 may also gamify an activity and provide encouragement to user making the apparatus more engaging. The apparatus 100 creates an exciting and motivating training environment.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components, and data files assisting in the performance of specific functions, the skilled person will understand that the functionality of the software application may be distributed across a number of routines, objects, or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An activity tracking apparatus for tracking performance of one or more activities by a user, the apparatus comprising:
a body,
a camera configured to capture one or more images of a user performing a physical activity,
wherein the activity tracking apparatus is configured to:
capture, by the camera, one or more images of a user performing a physical activity with an equipment,
process the one or more captured images and determine movement of the user,
process the one or more captured images and determine movement of the equipment,
identify a physical activity being performed by a user based on the movement of the user and the movement of the equipment.

2. An activity tracking apparatus in accordance with claim 1, wherein the camera is a stereo camera mounted on the body and, the stereo camera includes two cameras.

3. An activity tracking apparatus in accordance with claim 1, wherein the apparatus is configured to determine movement of the equipment by applying an object detection and tracking process.

4. An activity tracking apparatus in accordance with claim 1, further comprising an activity classification engine, the activity classification engine is configured to classify the movement of the equipment and the movement of the user and determine a type of physical activity based on the classified movement.

5. An activity tracking apparatus in accordance with claim 1, configured to apply an object tracking process to the captured images, as part of the object tracking process the apparatus is configured to:
identify the equipment within the captured images,
determine position of the equipment in multiple images, wherein each position denotes a discrete position of the equipment in three-dimensional (3D) space and,
determine the movement of the equipment based on the discrete positions of the equipment.

6. An activity tracking apparatus in accordance with claim 5, wherein as part of the object tracking process the apparatus is configured to determine a trajectory of the equipment by analysing the determined discrete position of the equipment across multiple consecutive images and determine the movement of the equipment based on the determined trajectory.

7. An activity tracking apparatus in accordance with claim 6, wherein the apparatus is configured to determine the physical activity being performed based on trajectory of the equipment.

8. An activity tracking apparatus in accordance with to claim 7, wherein as part of the object tracking process the apparatus is configured to determine changes in the position of the equipment relative to the user or a user body part in a plurality of consecutive captured images, and the apparatus configured to identify movement of the equipment based on the changes in relative position of the equipment to the user or user body parts.

9. An activity tracking apparatus in accordance with claim 8, wherein the apparatus is configured to identify a physical activity being performed by the user, based on the identified movement of the equipment relative to the user and/or relative to one or more body parts of the user.

10. An activity tracking apparatus in accordance with claim 9, wherein as part of the object tracking process the apparatus is configured:
to identify a reference object within a plurality of captured images,
identify the position of equipment relative to the reference object in the plurality of captured images,
identify movement of the equipment based on changes in the position of the equipment relative to the reference object in the plurality of captured images.

11. An activity tracking apparatus in accordance with claim 10, wherein the apparatus is configured to determine the type of physical activity being performed by the user based on the movement of the equipment relative to the reference object.

12. An activity tracking apparatus in accordance with claim 11, wherein as part of the object tracking the apparatus is configured to:
determine movement of the equipment relative to the user and relative to the reference object, and;
determine the type of physical activity being performed by the user based on the determined movement of the equipment relative to the user and relative to the reference object.

13. An activity tracking apparatus in accordance with claim 12, wherein the movement of the equipment is determined based on the distance travelled by the equipment and the distance travelled is determined based on the difference in positions of the equipment in multiple captured images.

14. An activity tracking apparatus in accordance with claim 13, wherein the apparatus is configured to:
receive motion data from one or more sensors mounted on the equipment,
process the received motion data to determine movement of the equipment,
identify a physical activity being performed by a user based on the determined movement.

15. An activity tracking apparatus in accordance with claim 14, wherein the apparatus is configured to determine movement of the user by applying a pose estimation process to each of the captured images.

16. An activity tracking apparatus in accordance with claim 15, wherein the apparatus is configured to apply a pose estimation process to the one or more captured images, as part of the pose estimation process the activity tracking apparatus configured to:
generate a wire frame model representative of the user body, the wire frame model comprising reference points,
the reference points representing joints and/or limbs of the user,
determine movement of the user based on one or more of:
calculating the change in relative angle between two or more predetermined reference points,
calculating the change in angle between one or more predetermined reference points and a reference object,
calculating the change in relative position of a plurality of predetermined reference points.

17. An activity tracking apparatus in accordance with claim 16, wherein the apparatus is configured to calculate a change of a user over multiple captured images and calculate a physical activity performed by a user based on the change, over multiple captured images.

18. An activity tracking apparatus in accordance with claim 17, wherein the apparatus is configured to calculate one or more metrics related the physical activity being performed by the user.

19. An activity tracking apparatus in accordance with claim 18 further comprising a user interface, the user interface configured to present information to a user and/or receive inputs from a user, and the apparatus configured to present via the user interface to a user one or more of:
the type of physical activity being performed,
the one or more metrics regarding the physical activity being performed,
a video stream of the user performing the physical activity,
instructions regarding how to perform a physical activity.

20. An activity tracking apparatus in accordance with claim 19, wherein the one or more metrics comprise one or more of: number of repetitions, quality of the activity, time the activity is performed, work done.

21.-27. (canceled)
